(19) United States
(12) Patent Application Publication
(10) Pub. No.: US 2013/0013475 A1
(43) Pub. Date: Jan. 10, 2013

(54) Issue Resolution

(75) Inventors: Shari L. Marakowitz, Mt. Holly, NC (US); Victoria G. Woodrome, Waterloo, IL (US); William Faux, Pittston, PA (US); Matthew T. Ahillen, Tempe, AZ (US); William Craig Etheredge, Ponte Vedra Beach, FL (US); Robert Wilfred Johnston, JR., Charlotte, NC (US)

(73) Assignee: Bank of America Corporation, Charlotte, NC (US)

(21) Appl. No.: 13/176,919

(22) Filed: Jul. 6, 2011

(51) Int. Cl. G06Q 40/00; G06Q 10/00

(52) U.S. Cl. 705/35; 705/304

(57) ABSTRACT

Systems and methods of resolving identified issues are provided. In at least some examples, the systems and methods may include receiving an identified issue, such as at an issue resolution system, and receiving one or more parameters associated with the identified issue. In some examples, the parameters may be hierarchical. The systems and methods may further include automatically generating a receipt associated with the issue and including a due date for resolution of the issue. The systems and methods may further include automatically routing the identified issue to a resolution group for resolution. In at least some examples, the systems and methods may include dynamically modifying aspects of the issue resolution system. For instance, the systems and methods described herein may include authenticating a user of a dynamic modification system and, upon authenticating the user, receiving one or more modifications to one or more aspects of the system. The modifications may be accepted and implemented in real-time or near real time.

### BACKGROUND

Customer service is important to the success of any business. Customers may understand that issues and problems may arise in any industry, however, how those problems or issues are resolved or otherwise addressed may either satisfy customers or may have them taking their business elsewhere. The best possible scenario is to take an unfortunate issue and turn it into a delighter for the customer by wowing them with service, knowledge, customer care and understanding. Customer service issues cannot always be avoided but it is important to solve them well for our customers.

One important factor in providing good customer service is speed. Customers want to have their problems or issues addressed promptly. In conventional arrangements, such as in a financial institution, a person may report a problem or issue to a teller or other front end worker. While this may be the easiest course of action for the customer, the teller or other front end worker may not have the time or expertise to resolve the issue. Accordingly, the teller may waste precious time trying to resolve the issue and may ultimately have to pass it along to someone else. This process can be inefficient, time consuming, and may leave the customer dissatisfied with the service they have received. Accordingly, a system and method of routing problems or issues to individuals having time and expertise to resolve the issues would be advantageous.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, systems and methods of resolving identified issues are provided. In some examples, the systems and methods may include receiving an identified issue, such as at an issue resolution system. The systems and methods may further include receiving one or more parameters associated with the identified issue. In some examples, the parameters may be hierarchical. The systems and methods may further include automatically generating a receipt associated with the issue and including a due date for resolution of the issue to set an expectation for the customer. The systems and methods may further include automatically routing the identified issue to a resolution group for resolution.

Other aspects of the systems and methods described herein may include dynamically modifying aspects of the issue resolution system. In at least some examples, the systems and methods described herein may include authenticating a user of a dynamic modification system and, upon authenticating the user, receiving one or more modifications to one or more aspects of the system. The modifications may be accepted and implemented in real-time or near real time.

### BRIEF DESCRIPTION OF THE DRAWINGS

The present disclosure is illustrated by way of example and not limited in the accompanying figures in which like reference numerals indicate similar elements.

FIG. 1 illustrates an example operating environment in which various aspects of the disclosure may be implemented.

FIG. 2 illustrates an example system for resolution of identified issues or problems according to one or more aspects described herein.

FIG. 3 illustrates one example method of resolving identified issues according to one or more aspects described herein.

FIGS. 4A-4C illustrate example user interfaces for identifying an issue for resolution and one or more parameters associated with the issue according to one or more aspects described herein.

FIG. 5 illustrates one example user interface requesting additional information or parameters associated with an identified issue according to one or more aspects described herein.

FIG. 6 illustrates one example receipt that may be automatically generated and may include a due date for resolution of the identified issue according to one or more aspects described herein.

FIG. 7 is one example user interface for managing a plurality of issues for resolution according to one or more aspects described herein.

FIG. 8 is one example method of dynamically modifying the issue resolution system according to one or more aspects described herein.

FIG. 9 is one example user interface for modifying one or more aspects of the issue resolution system according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

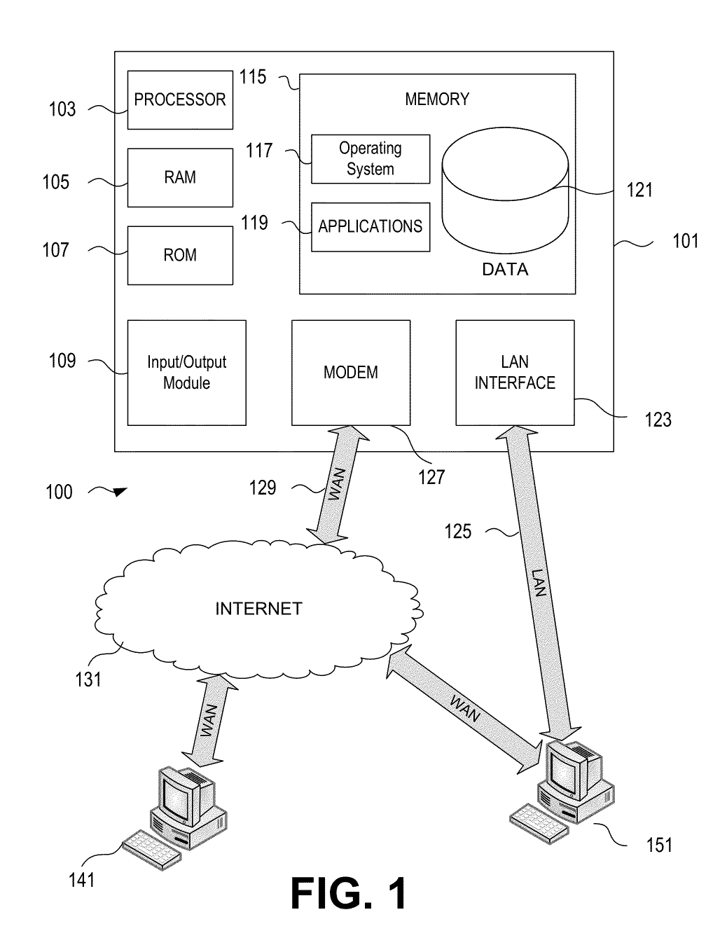

FIG. 1 illustrates a block diagram of a generic computing device 101 (e.g., a computer server) in computing environment 100 that may be used according to an illustrative embodiment of the disclosure. The computing device 101 may have a processor 103 for controlling overall operation of the device and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The computing device 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the server 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The above-described systems may be used in various businesses or corporate entities, such as financial institutions or other entities, to facilitate resolution of one or more issues that arise. For instance, in a financial institution, various banking issues, such as customer issues, may be submitted to the financial institution for resolution. Some example issues may include incorrect deposit amount, fraud on an account, check card, home loans, credit card, non-real estate loan, home equity, CD/IRA, safe box, on-line banking, treatment related issues, and the like. The systems and methods described herein may provide efficient ways to intake one or more issues, process the issues, resolve the issues and communicate the resolution to the individual reporting the issue/requesting resolution. Although several examples used herein may include reference to resolution of banking or banking related issues, the systems and methods described herein may be used in a variety of industries (e.g., service and non-service industries), corporations, businesses, government agencies, universities, and the like. Nothing in the specification or figures should be viewed as limiting the invention to only use with banking or banking related issues.

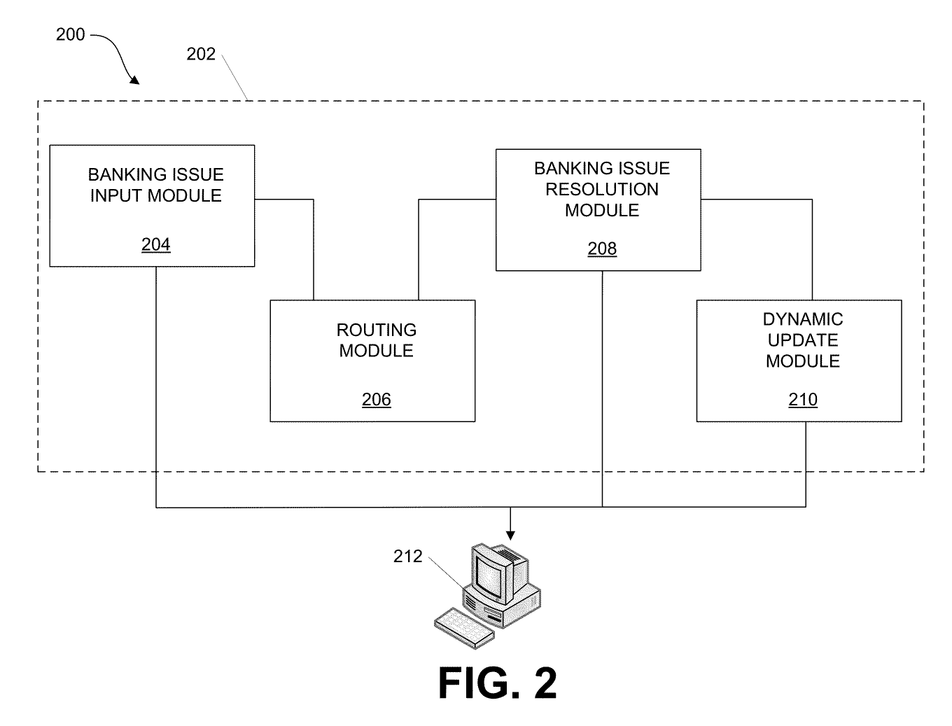

FIG. 2 illustrates one example issue resolution system for receiving, processing and resolving issues according to at least some examples described herein. The issue resolution system 200 may be part of or associated with an entity 202, such as the entity implementing the system. The entity may be a business, corporation, university or other educational institution, government agency, and the like. In some examples, the entity may be a financial institution, such as a bank. For simplicity, the issue resolution system 200 will be described in terms of a financial institution and may be described in the context of addressing, resolving, etc. banking issues. However, nothing in the specification or figures should be viewed as limiting the issue resolution system to only banks or banking related issues.

The issue resolution system 200 may include a banking issue input module 204. The banking issue input module 204 may receive identification of one or more banking issues, as well as additional information associated with the issues. For instance, if a banking issue arises or is reported, the issue identified, and any associated information, may be received by the banking issue input module 204. In some examples, this may include a banking associate inputting the identified issue into the banking issue input module 204, such as via computing device 212. Computing device 212 may include any computing device, such as a desktop computer, laptop computer, cell phone, smart phone, tablet pc, and the like. In some arrangements, and as will be discussed more fully below, the banking associate may input the identified issue into the issue input module 204 via one or more user interfaces. Additional information may also be input, such as type or category of issue, group or department associated with the issue, etc. This additional information may include one or more parameters for processing and/or resolving the issue.

For example, in some arrangements, the banking issue input module 204 may include a plurality of issue parameter input fields that may, in some examples, be hierarchical in nature. For instance, in a first issue parameter field, a first category or description of the issue may be identified. In some examples, the first category or description may be automatically identified based on issue information input into the banking issue input module 204. In other examples, the first category or description may be selected by a user, such as a banking associate. A second category or description of the issue may then be identified. In some arrangements, the second category or description may be determined from a plurality of descriptions identified from the first category or description identified. That is, selection of first category or description 1 may result in a first plurality of second descriptions for selection, while selection of first category or description 2 may provide a second plurality of second descriptions for selection. Additional levels of categories or descriptions may be provided, as will be discussed more fully below.

Identified issues and associated parameters may be transmitted from the banking issue input module 204 to a banking issue routing module 206. The banking issue routing module 206 may include one or more mapping arrangements to route identified issues to one or more issue resolution groups for resolution of the identified issue. For instance, an issue with a credit card transaction may be routed to, for example, a card issue resolution group, while an issue with a deposit may be routed to, for example, a deposit/withdrawal resolution group. A plurality of resolution groups may be identified and the identified issue may be automatically routed to an appropriate resolution group based on the parameters associated with the issue, as will be discussed more fully below. Further, the routing module 206 may route an issue to a group or resolution associate within the group having sufficient bandwidth to address/resolve the issue prior to the due date.

The issue resolution system 200 may further include a banking issue resolution module 208. The banking issue resolution module 208 may include a status of the one or more issues identified and being processed (e.g., in progress, complete, awaiting additional information, etc.). In some examples, a user, such as a banking associate or resolution associate, may interface with the banking issue resolution module 208 in order to resolve the identified issue. The resolution associate may interface with the banking issue resolution module 208 via one or more computing devices 212, which may include any type of computing device.

The issue resolution system 200 may further include a dynamic update module 210. In some arrangements, the dynamic update module 210 may permit a user, such as a system administrator, to update one or more aspects of the issue resolution system 200. For example, a system administrator may access the dynamic update module 210 in order to add additional categories or descriptions of issues, modify routing maps for resolution of issues, and the like. The modifications made via the dynamic update module 210 may be done in real-time or near real-time such that changes made will take effect immediately upon submission to the system. Various aspects of these modifications will be discussed more fully below.

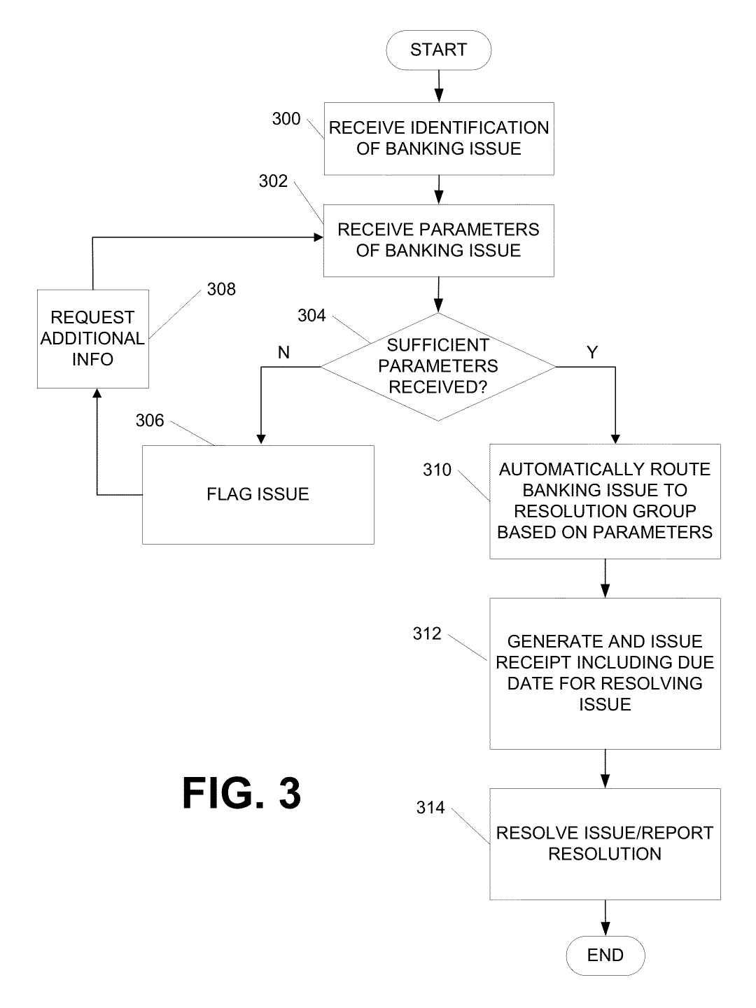

FIG. 3 illustrates one example method of issue resolution according to one or more aspects described herein. In step 300, a banking issue is received, such as at the banking issue input module 204. In step 302, one or more parameters associated with the received issue are received. For instance, the one or more parameters may include a description or category of the issue. In some examples, a plurality of issue descriptions or categories may be provided as parameters and, in some arrangements, the issue descriptions and categories may be hierarchical in nature. That is, categories or descriptions available for selection may be based on a previous category or description selected. For example, selection of the first category or description may determine which categories or descriptions are available for selection in a next level parameter. Likewise, selection of the second category or description may determine the categories or descriptions available for selection in the next level. Identification of the available categories or descriptions may be performed using one or more filters to identify categories or descriptions associated with the previously selected category or description.

In step 304, a determination is made as to whether sufficient parameters have been received. For instance, submission of a first set of parameters may require additional information for processing. Accordingly, in step 306, the issue may be flagged as having insufficient information and a request for additional information may be transmitted, for instance, to a user, in step 308. The process may then return to step 302 to receive additional parameters providing sufficient information to resolve the issue.

If, in step 304, sufficient parameters have been received, the received issue may be automatically routed to a resolution group based on the received parameters, in step 310. In some processes, a receipt may be generated, as in step 312. The receipt may include an identifier of the issue, such as a tracking number, and may include a due date or date on which the issue is expected to be resolved. The receipt may be automatically generated and may be submitted to a customer or other individual reporting the issue. In step 314, the issue may be resolved and a notification may be transmitted indicating that the issue is resolved.

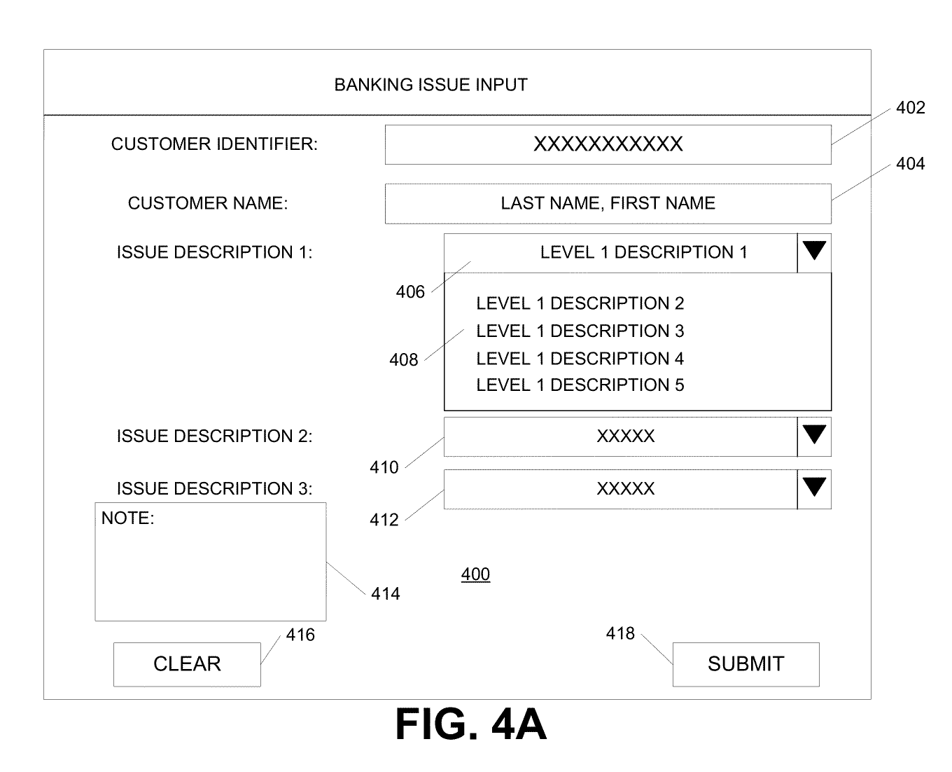

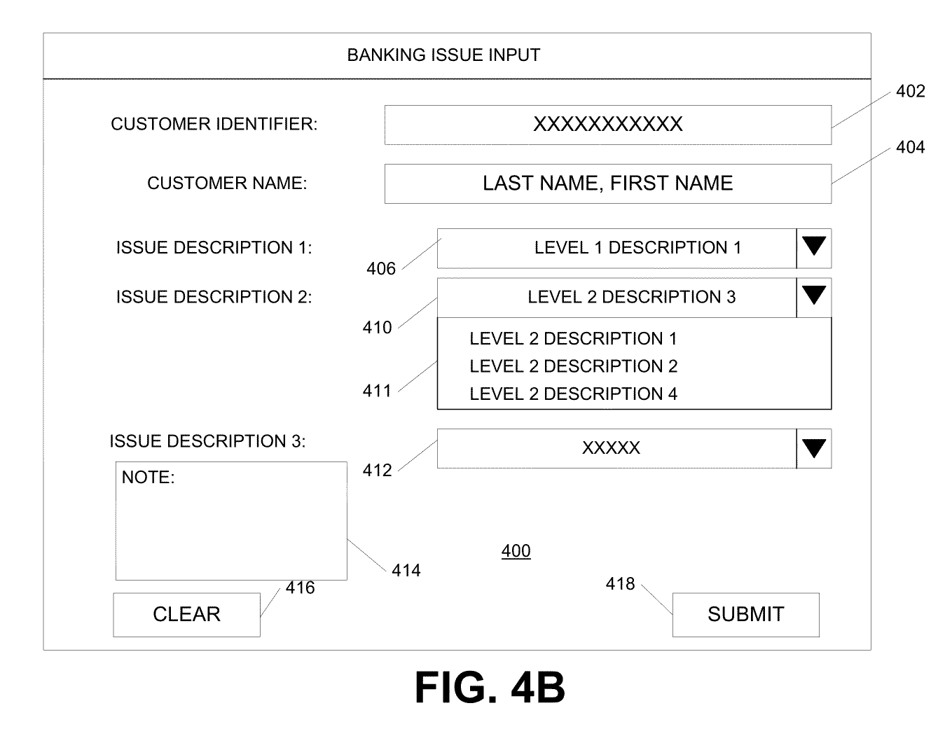

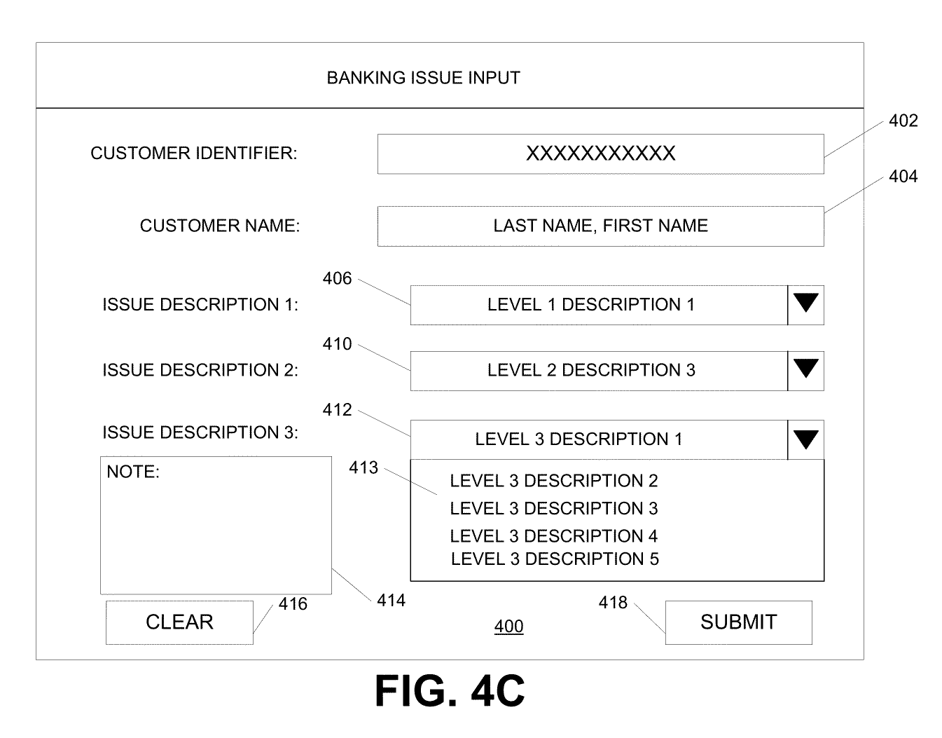

FIG. 4A illustrates one example user interface 400 for inputting identified issue information and parameters associated with the issue. The interface 400 may include an identifier 402, which may identify an individual, customer, entity, etc. reporting or identifying the banking issue. Field 404 may provide a name associated with the identifier in field 402. The name may be automatically populated based on the identifier in field 402, or may be input, such as by a banking associate. In field 406, a first level issue category or description may be identified. In some examples, the first level issue category or description may be selected from a list, such as list 408, displayed in a drop-down menu format. Various other methods of displaying categories or descriptions available for selection may be used without departing from the invention. Further, the number and nature of the descriptions/categories provided is merely provided as an example. More or fewer descriptions may be provided without departing from the invention. In some examples, the initial category or description may be selected from a list including products, services, home loan, certificate of deposit, individual retirement account, on-line banking, deposit, and the like.

The interface 400 may include fields 410 and 412 for identifying additional parameters associated with the identified issue. In some examples, the parameters in field 410 and/or 412 may include additional categories or descriptions available for selection based on the category or description selected in field 406, as will be discussed below.

Interface 400 may further include a note region 414 in which a user may include one or more notes or additional information about the identified issue. The interface may further include a clear option 416 which may clear all selections made and/or any information input into the interface 400, as well as a submit option 418 which may process the information input into the interface 400.

FIG. 4B illustrates the interface 400 with a second parameter region expanded. That is, region 411 includes a plurality of descriptions or categories for selection. As discussed above, the categories or descriptions provided in region 411 may be hierarchical in nature and may be provided based on the selection of category or description in field 406. Again, the number of descriptions provided is merely one example. More or fewer categories or descriptions may be provided without departing from the invention. In some examples, the descriptions or categories provided in field 411 may include functions of a product or service identified in field 406, types of deposits, account maintenance, account research, request for documents or correspondence, monetary adjustments, loan payoff, enrollments, payoffs, and the like. The descriptions or categories in field 411 may be provided based on the item selected in field 406.

FIG. 4C illustrates the interface 400 with another parameter region expanded. Similar to the arrangements discussed above, the parameter region 413 includes a plurality of descriptions and/or categories for selection. The descriptions provided for selection may be based on selection of the description category in field 410 and, in some examples, the description/category selected in field 406. The descriptions/categories provided in field 413 may include further descriptions of the problem or issue identified. Once the desired descriptions/categories have been selected, a user may select submit option 418 to process the issue and associated parameters.

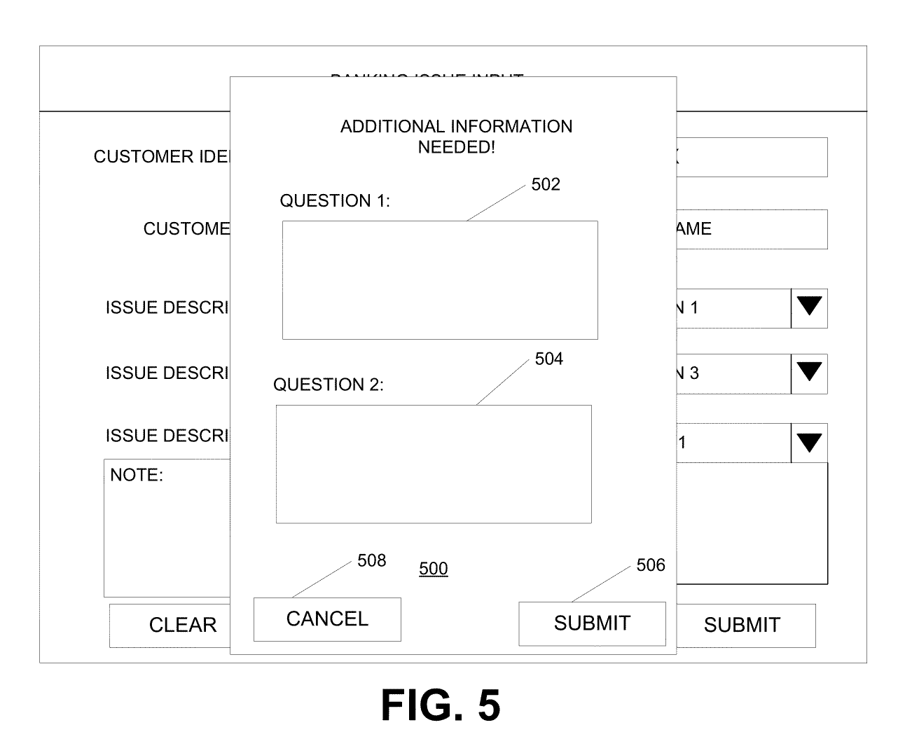

FIG. 5 illustrates one example request for additional information interface according to one or more aspects described herein. The interface 500 may, in some examples, appear upon submission of an issue and associated parameters (e.g., submission of the interface 400 in FIGS. 4A-4C). In some arrangements, additional information may be required to process or resolve an issue. Accordingly, rather than begin processing the issue and have to return to the individual reporting the issue to ask for the additional information, a pop-up interface, such as interface 500, may appear almost immediately upon submission of the issue. The interface 500 may include one or more questions or requests for additional information. The additional information may be provided in one or more fields, such as fields 502 and 504. Upon completion, the user may select submit option 506 or, in some examples, may select cancel option 508, which may remove the pop-up interface 500 from the screen.

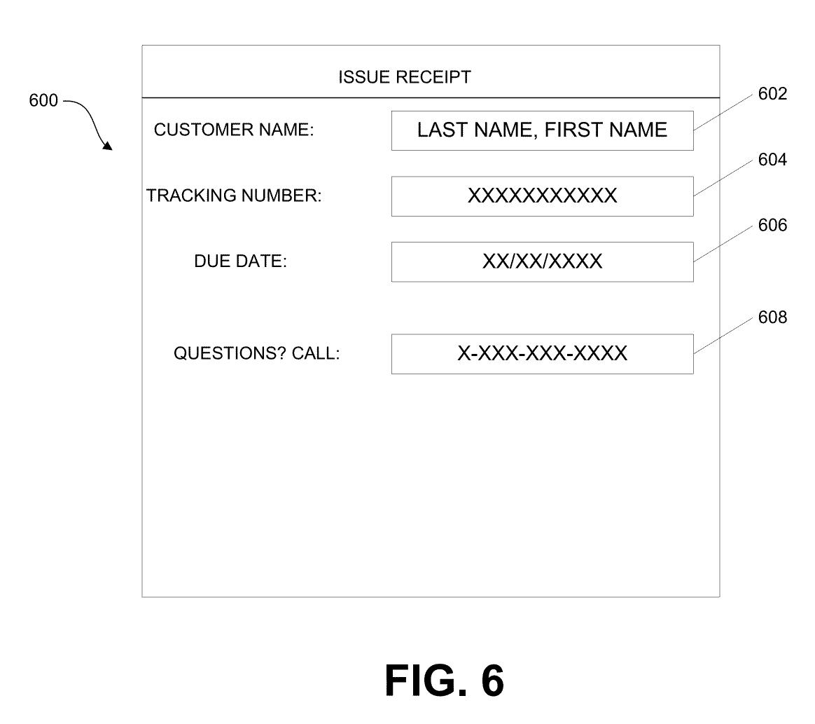

As discussed above, upon submission of the issue, a receipt may be generated. One example receipt 600 is illustrated in FIG. 6. The receipt may include a name of an individual associated with the issue in field 602. For instance, the name of the person reporting the issue may be provided. The receipt may also include a tracking number or other identifier in field 604. The tracking number may be a unique identifier associated with the identified issue and may be used to review the status of the issue, etc. In some examples, the tracking number may be an alphanumeric identifier.

The receipt 600 may also include a due date in field 606. The due date may be automatically generated based on the issue identified, parameters associated with the issue, etc. The due date may indicate when the person reporting the issue may expect the issue to be resolved. Further, the due date may be transmitted to the resolution group to which the issue has been routed and may also provide an indication to the resolution associate working to resolve the issue of when the issue should be resolved. In some examples, the receipt may also include a telephone number or other contact information in field 608. If the person identifying the issue, such as a customer, etc., would like to check the status of resolution of the issue, or if the due date has passed, etc., the person may use the contact information provided in field 608 to do so. In some examples, the receipt may be a hard copy printed out and provided to the person or customer reporting the issue. In other examples, the receipt may be faxed, emailed, etc. to the individual.

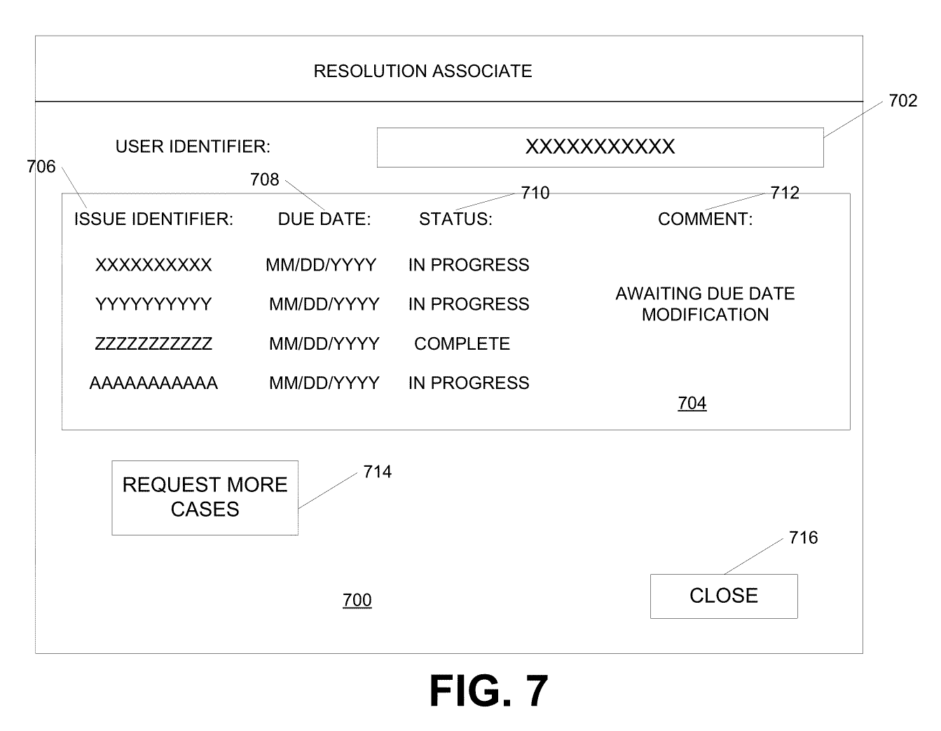

FIG. 7 illustrates one example user interface that may be used by a resolution associate in resolving one or more identified issues. The interface 700 may include a user identifier, such as an employee number, associate name, etc., in field 702. Field 704 is generally an issue resolution queue. The issue resolution queue 704 includes some or all issues assigned to the resolution associate, as well as additional information associated with the issues. For instance, an issue identifier (e.g., tracking number, etc.) is provided in column 706. The due date for resolution of the issue is provided in column 708. In some examples, the issues for resolution may be sorted by due date such that issues having earliest due dates are shown at the top of the queue. In some examples, failure to complete resolution of the issue by the due date may result in a notification being sent to the resolution associate assigned to that issue. For instance, a notification may be sent on the due date itself or the day after the due date. In some examples, the notification may be sent via email, SMS, and the like. Additionally or alternatively, the notification may appear on the issue resolution interface, such as interface 700. Further, a notification may also be sent to a manager or supervisor of the issue resolution associate indicating that the due date has passed.

The issue resolution interface 700 may further include a status column 710 in issue resolution queue 704. The status column 710 may indicate whether the issue is still being worked on (e.g., in progress) or has been completed. Column 712 provides a region for a comment to be inserted regarding the issue. For instance, a resolution associate may provide further details on the status of resolution, whether there is a hold-up or other delay with resolution, etc. In some examples, to work on resolution of a case, or to modify information associated with the issue in the issue resolution queue 704, a resolution associate may select the issue from the queue, such as by clicking or double-clicking on the desired issue. Selection of the issue may prompt one or more additional interfaces that may aid in facilitating resolution of the issue. For instance, the additional interfaces may include steps taken to resolve an issue, categories of resolution of the issue, comment types, etc. In some arrangements, one or more attachments may be included with the issue or in one or more issue resolution screens. Additionally or alternatively, upon completion of resolution of an issue, a completion interface may be provided in which the resolution associate may mark the issue complete and may identify a category for the solution to the issue. These solutions and issues may then be tracked to provide historical information about issues, resolutions, etc.

The issue resolution interface 700 may further include an option to request additional cases 714. In some examples, resolution associates may be rated based on number of issues resolved, efficiency in resolving issues, etc. Accordingly, an associate may request additional issues to resolve in order to increase productivity or manage their workload. The interface 700 may further include a close option 716 to close out of the interface.

One advantage to the resolution system provided herein is ease of access. That is, the system may be accessed from various locations and, in some examples, may be accessed from anywhere, such as via the Internet. Accordingly, issues for resolution may be processed by resolution associates in locations remote from the location initially receiving the report of the issue. This provides more efficient resolution of issues because issues can be assigned to associates based on knowledge or expertise, bandwidth, etc., regardless of the location of the resolution associate or resolution group.

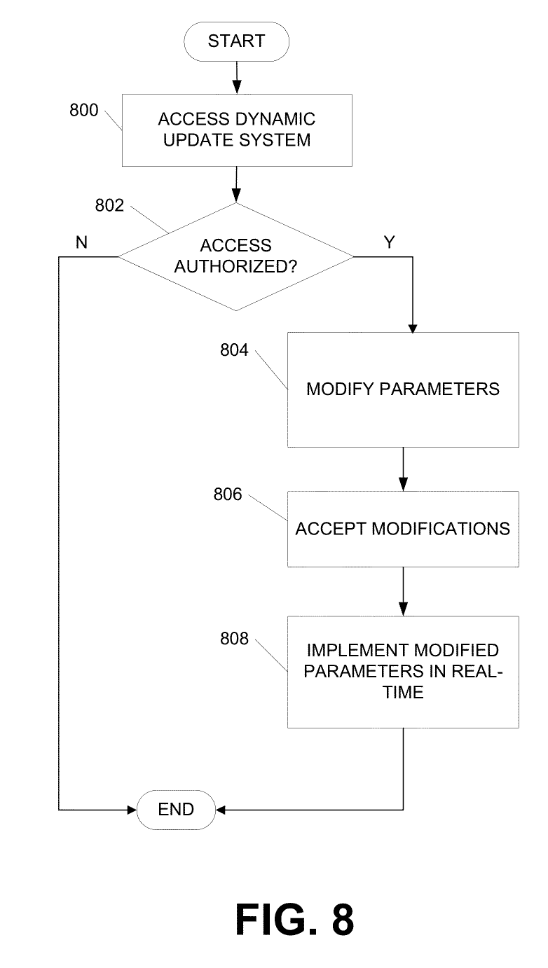

As discussed above, the issue resolution system may include dynamic modification capability. For instance, an administrator, or other individual with access to the dynamic modification system, may dynamically update one or more aspects of the issue resolution system such that modifications will take place in real-time or near real-time. FIG. 8 illustrates one example method of dynamically updating or modifying the issue resolution system. In step 800, the dynamic update system or module may be accessed. In step 802, a determination is made as to whether the access is authorized. For instance, a determination is made as to whether the individual accessing the system is authorized or had privileges to do so (e.g., is an administrator, etc.). Authorization may be confirmed by validation of login information, such as a username and password. If the access is unauthorized, the process may end. If the access is authorized, one or more parameters of the system may be modified in step 804. For instance, the categories or descriptions of issues may be modified or one or more categories or descriptions may be added or deleted. Additionally or alternatively, the routing of an issue may be modified or a request for additional information or parameters may be modified, added or removed. In step 806, one or more modifications may be accepted and in step 808 the modifications may be implemented in real-time or near real-time. Accordingly, modifications to the system can be made with relative ease to ensure the issue resolution system is up-to-date and can be modified to accommodate new issues that arise, etc.

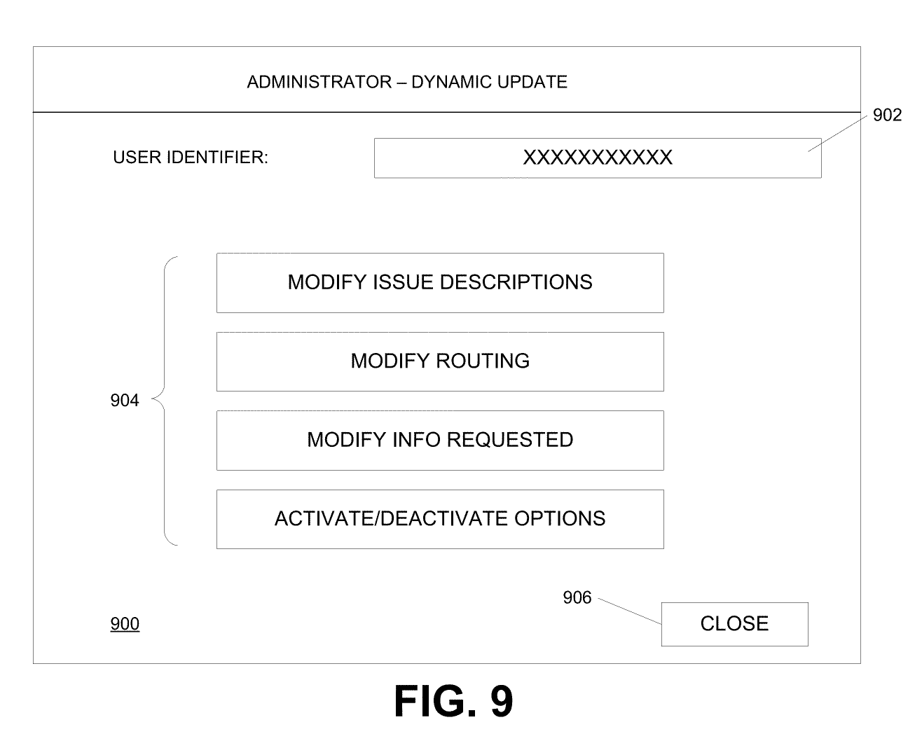

FIG. 9 illustrates one example user interface 900 for modifying one or more aspects of the issue resolution system. The interface 900 includes a user identifier field 902. The user identifier field may identify the user (e.g., administrator, etc.) modifying the system. The user identifier may be a name, employee number, etc. The interface 900 may further include one or more options 904 for modifying one or more aspects of the issue resolution system. Although four example modifications are shown, more or fewer options may be available without departing from the invention. Selection of one of the modification options 904 may prompt additional screens and/or interfaces in which one or more modifications may be made to the system. The interface 900 may further include a close option 906 which will close the interface 900.

The issue resolutions systems and methods described herein provide an efficient manner of addressing and resolving issues or problems identified. The systems and methods will improve speed of resolution since the issue may be automatically routed to a person or group for resolution. Further, the automatic routing system may ensure that issues are routed to individuals or groups with the appropriate expertise for resolution and with bandwidth to handle resolution of the issue. Further, the system improves customer service by providing a due date for resolution to the customer, as well as contact information for a customer to check the status of resolution of the issue.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

What is claimed is:

1. An apparatus, comprising:
at least one processor; and
memory operatively coupled to the processor and storing computer readable instructions that, when executed, cause the apparatus to:
receive identification of a banking issue;
receive a first parameter of the banking issue;
receive a second parameter of the banking issue, wherein the second parameter is selected from a list of parameters provided based on the received first parameter;
automatically generate a banking issue receipt including at least a due date for resolution of the banking issue, the due date being generated by a banking issue resolution system; and
automatically route the banking issue to a banking issue resolution group based on the identified banking issue and received first and second parameters of the banking issue.

2. The apparatus of claim 1, wherein the instructions, when executed, further cause the apparatus to transmit the receipt to a customer reporting the banking issue.

3. The apparatus of claim 1, wherein the instructions, when executed, further cause the apparatus to receive a third parameter of the banking issue, wherein the third parameter is selected from a list of parameters provided based on the received second parameter.

4. The apparatus of claim 1, further including determining whether sufficient parameters have been received and, responsive to determining that sufficient parameters have not been received, transmitting a request for additional information.

5. The apparatus of claim 1, wherein the identification of the banking issue is received at a first location and the banking issue resolution group is located at a second location different from the first location.

6. A method, comprising:
receiving, by a banking issue resolution system, identification of a banking issue;
receiving, by the banking issue resolution system, user input identifying parameters of the banking issue;
automatically generating, by the banking issue resolution system, a banking issue receipt including at least a due date for resolution of the banking issue, the due date being generated by the banking resolution system; and
automatically routing the banking issue to a banking issue resolution group based on the identified banking issue and identified parameters of the banking issue.

7. The method of claim 6, further including transmitting the receipt to a customer reporting the banking issue.

8. The method of claim 6, wherein the parameters include a plurality of hierarchical levels of parameters.

9. The method of claim 6, wherein the plurality of hierarchical levels includes at least three levels.

10. The method of claim 6, further including determining whether sufficient parameters have been received and, responsive to determining that sufficient parameters have not been received, transmitting a request for additional information.

11. The method of claim 6, wherein the identification of the banking issue is received at a first location and the banking issue resolution group is located at a second location different from the first location.

12. One or more non-transitory computer readable media storing computer readable instructions that, when executed, cause an issue resolution system of a financial institution to:
receive, by the issue resolution system, identification of a banking issue;
receive parameters of the banking issue;
automatically generate, by the banking issue resolution system, a banking issue receipt including at least a due date for resolution of the banking issue, the due date being generated by the issue resolution system; and
automatically route the banking issue to a banking issue resolution group based on the identified banking issue and the received parameters of the banking issue.

13. The one or more non-transitory computer readable media of claim 12, further including transmitting the receipt to a customer reporting the banking issue.

14. The one or more non-transitory computer readable media of claim 12, wherein the parameters include a plurality of hierarchical levels of parameters.

15. The one or more non-transitory computer readable media of claim 12, wherein the plurality of hierarchical levels includes at least three levels.

16. The one or more non-transitory computer readable media of claim 12, further including determining whether sufficient parameters have been received and, responsive to determining that sufficient parameters have not been received, transmitting a request for additional information.

17. The one or more non-transitory computer readable media of claim 12, wherein the identification of the banking issue is received at a first location and the banking issue resolution group is located at a second location different from the first location.

18. A method, comprising:
receiving, by a dynamic update system of an issue resolution system, a request to access the dynamic update system;
authenticating the request to access the dynamic update system;
receiving, by the dynamic update system, at least one modification to an aspect of the issue resolution system; and
implementing the at least one modification in real-time.

19. The method of claim 18, wherein the aspect of the issue resolution system includes at least one of: a category or description of an issue, a routing of an issue for resolution, and a request for additional information.

20. The method of claim 18, wherein the at least one modification includes adding or removing a category or description of an issue.

21. The method of claim 18, wherein the at least one modification includes modifying a routing map for resolution of an issue.
